(19) United States
(12) Patent Application Publication
(10) Pub. No.: US 2017/0023715 A1
(43) Pub. Date: Jan. 26, 2017

(54) OPTICAL FILM, MANUFACTURING METHOD THEREOF, AND DISPLAY DEVICE

(71) Applicants: SAMSUNG ELECTRONICS CO., LTD., Suwon-si (KR); SAMSUNG SDI CO., LTD., Yongin-si (KR)

(72) Inventors: Ha Na Kim, Yongin-si (KR); Taehyun Lee, Suwon-si (KR); Sangah Gam, Seoul (KR); Myung-Sup Jung, Seongnam-si (KR)

(21) Appl. No.: 15/002,595

(22) Filed: Jan. 21, 2016

(30) Foreign Application Priority Data
Jul. 22, 2015 (KR) 10-2015-0103716

(51) Int. Cl. G02B 5/30; B32B 37/14; B32B 37/12

(52) U.S. Cl. CPC G02B 5/3016; G02B 5/305; G02B 5/3083; B32B 37/12; B32B 37/14; B32B 2551/00

(57) ABSTRACT

An optical film includes a polarizing film including a polyolefin and a dichroic dye, a phase delay layer positioned on one side of the polarizing film, and a curable adhesive positioned between the polarizing film and the phase delay layer. A method of manufacturing the optical film, and a display device including the optical film are also disclosed.

### CROSS-REFERENCE TO RELATED APPLICATION

This application claims priority to and the benefit of Korean Patent Application No. 10-2015-0103716 filed on Jul. 22, 2015, and all the benefits accruing therefrom under 35 U.S.C. §119, the content of which in its entirety is incorporated herein by reference.

### BACKGROUND

1. Field

An optical film, a manufacturing method thereof, and a display device are disclosed.

2. Description of the Related Art

Commonly used flat panel displays may be classified into a light-emitting display device capable of emitting light by itself and a non-emissive display device requiring a separate light source. A compensation film such as a retardation film is frequently employed for improving the image quality of the flat panel display.

In the case of the light emitting display device, for example, an organic light emitting display, the visibility and the contrast ratio may be deteriorated by reflection of external light caused by a metal such as an electrode. In order to reduce reflection of external light, the linear polarized light is shifted into circularly polarized light using a polarizing plate and a retardation film, so that reflection of the external light by the organic light emitting display and leakage thereof to the outside, may be prevented.

Thus, there remains a need for improved light emitting display devices.

### SUMMARY

One embodiment provides an optical film having improved durability and a thin thickness.

Another embodiment provides a method of manufacturing the optical film.

Yet another embodiment provides a display device including the optical film.

According to one embodiment, provided is an optical film including: a polarizing film including a polyolefin and a dichroic dye; a phase delay layer disposed on the polarizing film; and a curable adhesive disposed between the polarizing film and the phase delay layer.

In another embodiment, the curable adhesive may be a photo-curable adhesive or a thermosetting adhesive.

In yet another embodiment, the curable adhesive may have a thickness of less than or equal to about 5 μm.

In an embodiment, the surface of the polarizing film may be treated with a corona treatment, a plasma treatment, or a halogenation treatment.

In an embodiment, the optical film may further include an auxiliary layer disposed between the polarizing film and the curable adhesive.

In another embodiment, the auxiliary layer may include a halogenated polyolefin.

In yet another embodiment, the phase delay layer may include a first phase delay layer and a second phase delay layer having different in-plane retardation from each other, and the optical film may further include a curable adhesive disposed between the first phase delay layer and the second phase delay layer.

In an embodiment, the in-plane retardation of the first phase delay layer may range from about 110 nanometers (nm) to about 160 nm for a wavelength of about 550 nm, and the in-plane retardation of the second phase delay layer may range from about 230 nm to about 300 nm for the wavelength of about 550 nm.

In an embodiment, the phase delay layer may be a liquid crystal layer.

In another embodiment, the phase delay layer may include a first phase delay layer and a second phase delay layer having different in-plane retardation from each other and each including liquid crystal molecules. The optical film may further include a curable adhesive disposed between the first phase delay layer and the second phase delay layer.

The phase delay layer may have a thickness of less than or equal to about 10 micrometers (μm).

The polarizing film may have a thickness of less than or equal to about 100 μm.

The optical film may has a tensile modulus of greater than or equal to about 1800 MPa and a surface hardness of greater than or equal to about 90 N/mm² as measured for each of the polarizing film and the phase delay layer.

According to another embodiment, a display device including the optical film is provided.

According to a further embodiment, provided is a method of manufacturing an optical film including: melt-blending a polyolefin and a dichroic dye to prepare a polarizing film; providing a phase delay layer; and binding the polarizing film and the phase delay layer using a curable adhesive.

In an embodiment, providing the phase delay layer may include forming a liquid crystal layer.

In an embodiment, the manufacturing method may further include applying the curable adhesive on the polarizing film after preparing the polarizing film, and binding the polarizing film and the phase delay layer may include disposing the curable adhesive and the phase delay layer to face each other and transferring the phase delay layer onto the curable adhesive.

In an embodiment, providing the phase delay layer may include providing each of the first phase delay layer and the second phase delay layer, and binding the first phase delay layer and the second phase delay layer using a curable adhesive, and the first phase delay layer and second phase delay layer have different in-plane retardation from each other.

In an embodiment, the manufacturing method may further include treating the polarizing film with corona treatment, plasma treatment, or halogenation treatment after preparing the polarizing film.

The manufacturing method may further include disposing an auxiliary layer including a halogenated polyolefin on the polarizing film after preparing the polarizing film.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a schematic cross-sectional view of an embodiment of an optical film.

FIG. 2 is a schematic cross-sectional view of another embodiment of an optical film.

FIG. 3 is a schematic cross-sectional view of yet another embodiment of an optical film.

FIG. 4 is a schematic cross-sectional view of an embodiment of an optical film.

FIG. 5 is a schematic view illustrating the external light anti-reflection principle of an embodiment of an optical film.

FIG. 6 is a schematic cross-sectional view of a polarization film in the optical film of FIG. 1.

FIG. 7 is a schematic cross-sectional view of an embodiment of an organic light emitting display.

FIG. 8 is a schematic cross-sectional view of an embodiment of liquid crystal display (LCD) device according to one embodiment.

FIG. 9 is a photograph of an optical film according to Example 5 taken after performing a bending test.

FIG. 10 is a photograph of an optical film according to Example 6 taken after performing a bending test.

FIG. 11 is a photograph of an optical film according to Comparative Example 1 taken after performing a bending test.

FIG. 12 is a photograph of an optical film according to Example 5 attached with a reflector after performing a bending test.

FIG. 13 is an appearance photograph of an optical film according to Example 6 attached with a reflector after performing a bending test.

FIG. 14 is an appearance photograph of an optical film according to Comparative Example 1 attached with a reflector after performing a bending test.

### DETAILED DESCRIPTION

Reference will now be made in detail to exemplary embodiments, examples of which are illustrated in the accompanying drawings. However, this disclosure may be embodied in many different forms and is not construed as limited to the exemplary embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The liquid crystal display (LCD), which is a light-receiving display device, changes linear polarized light into circularly polarized light to improve the image quality according to the type of device. For example, the device may be transparent, transflective, reflective, and so on.

However, previously developed optical films have weak durability which has an effect on the display quality of the device. In addition, the optical films have drawbacks when making thin display devices due to their thickness.

Hereinafter, an exemplary embodiment of an optical film is described with reference to the drawings.

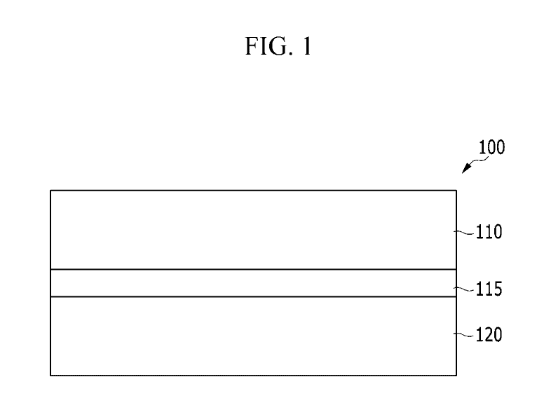

FIG. 1 is a schematic cross-sectional view of an optical film according to one embodiment.

Referring to FIG. 1, an exemplary embodiment of an optical film 100 includes a polarizing film 110, a phase delay layer, 120 and a curable adhesive 115 disposed between the polarizing film 110 and the phase delay layer 120.

The phase delay layer 120 may have an in-plane retardation of about 110 nm to about 160 nm for a wavelength of, for example, about 550 nm, which may be, for example, a λ/4 plate. The phase delay layer 120 may circularly-polarize light passing through the polarizing film 110 to generate a phase difference in the light, and thus may influence reflection and/or absorption of light.

For example, the optical film 100 may be positioned on one side or both sides of the display device. In particular, the optical film may prevent light from the outside (hereinafter referred to as ‘external light’) from flowing into the display portion of the display device and being reflected. Accordingly, the optical film may prevent the deterioration in visibility caused by external light reflection.

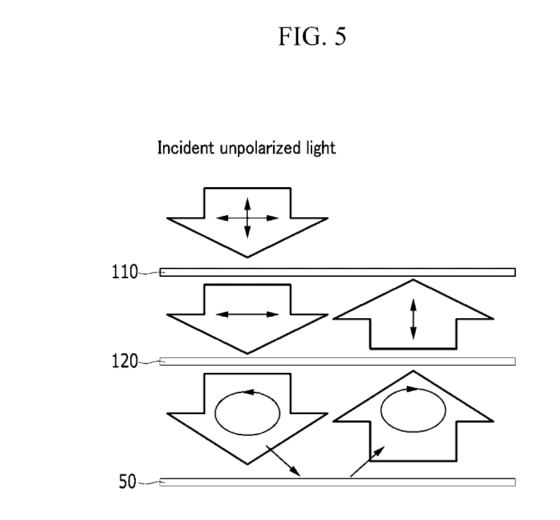

FIG. 5 is a schematic view showing the external light anti-reflection principle of an optical film.

Referring to FIG. 5, incident unpolarized light having entered from the outside is passed through the polarization film 110. The polarized light is shifted into circularly polarized light when is passes through the phase delay layer 120, however, only a first polarized perpendicular component, which is one of two polarized perpendicular components, is transmitted. The circularly polarized light is reflected by a display panel 50 including a substrate, an electrode, and so on, which changes the circular polarization direction, and as a result, the circularly polarized light is passed through the phase delay layer 120 again, but this time only the second polarized perpendicular component, which is the other polarized perpendicular component of the two polarized perpendicular components, may be transmitted. Since the second polarized perpendicular component is not passed through the polarization film 110, light does not exit to the outside, and external light reflection may be prevented.

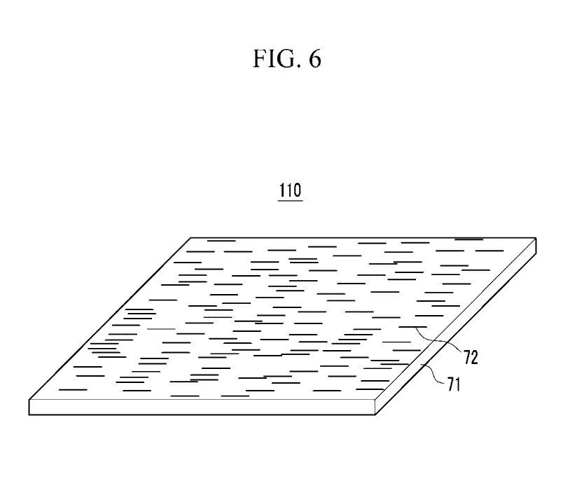

FIG. 6 is a cross-sectional schematic view of a polarization film 110 in the optical film of FIG. 1.

Referring to FIG. 6, the polarizing film 110 may be an integrated elongation film made of a melt blend of a polyolefin 71 and a dichroic dye 72.

The polyolefin 71 may beat least one selected from polyethylene (PE), polypropylene (PP), a copolymer of polyethylene and polypropylene (PE-PP), and a mixture of polypropylene (PP) and a polyethylene-polypropylene copolymer (PE-PP).

The polypropylene (PP) may have, for example, a melt flow index (MFI) of about 0.1 grams per 10 minutes (g/10 min) to about 5 g/10 min. Herein, the melt flow index (MFI) reflects the amount of a polymer (g) in a melted state which flows over a period of 10 minutes, and relates to the viscosity of the polyolefin in a molten state. In other words, the lower the melt flow index (MFI), the higher the viscosity of the polyolefin, and similarly, the higher the melt flow index (MFI), the lower the viscosity of the polyolefin. When the polypropylene (PP) has a melt flow index (MFI) within the desired range, the properties of the final product as well as workability of the product may be effectively improved. Specifically, the polypropylene may have a melt flow index (MFI) ranging from about 0.5 g/10 min to about 5 g/10 min.

The polyethylene-polypropylene copolymer (PE-PP) may include about 1 weight percent (wt %) to about 50 wt % of an ethylene group based on the total weight of the copolymer. When the polyethylene-polypropylene copolymer (PE-PP) includes the ethylene group within this range, phase separation of the polypropylene from the polyethylene-polypropylene copolymer (PE-PP) may be effectively prevented or suppressed. In addition, the polyethylene-polypropylene copolymer (PE-PP) may improve elongation rate during elongation of the film as well as provide excellent light transmittance and alignment-improving polarization characteristics. Specifically, the polyethylene-polypropylene copolymer (PE-PP) may include an ethylene group in an amount of about 1 wt % to about 25 wt % based on the total weight of the PE-PP copolymer.

The polyethylene-polypropylene copolymer (PE-PP) may have a melt flow index (MFI) ranging from about 5 g/10 min to about 15 g/10 min. When the polyethylene-polypropylene copolymer (PE-PP) has a melt flow index (MFI) within this range, the properties of the final product as well as workability may be effectively improved. Specifically, the polyethylene-polypropylene copolymer (PE-PP) may have a melt flow index (MFI) ranging from about 10 g/10 min to about 15 g/10 min.

The polyolefin 71 may include polypropylene (PP) and a polyethylene-polypropylene copolymer (PE-PP) in a weight ratio of about 1:9 to about 9:1. When the polypropylene (PP) and the polyethylene-polypropylene copolymer (PE-PP) are included within this range, the polypropylene may be prevented from crystallizing and may have excellent mechanical strength, thus effectively improving the haze characteristics. Specifically, the polyolefin 71 may include the polypropylene (PP) and the polyethylene-polypropylene copolymer (PE-PP) in a weight ratio of about 4:6 to about 6:4, and more specifically, in a weight ratio of about 5:5.

The polyolefin 71 may have a melt flow index (MFI) ranging from about 1 g/10 min to about 15 g/10 min. When the polyolefin 71 has a melt flow index (MFI) within this range, the polyolefin may not only secure excellent light transmittance since crystals are not excessively formed in the resin, but the polyolefin may also have a viscosity appropriate for manufacturing a film and thus have improved workability. Specifically, the polyolefin 71 may have a melt flow index (MFI) ranging from about 5 g/10 min to about 15 g/10 min.

The polyolefin 71 may have haze ranging from less than or equal to about 5%. When the polyolefin 71 has haze within this range, light transmittance may be increased, and thus the layer may possess excellent optical properties. Specifically, the polyolefin 71 may have haze of less than or equal to about 2%, and more specifically, about 0.5% to about 2%.

The polyolefin 71 may have crystallinity of less than or equal to about 50%. When the polyolefin 71 has crystallinity within this range, the polyolefin may have lower haze and excellent optical properties. Specifically, the polyolefin 71 may have crystallinity of about 30% to about 50%.

The polyolefin 71 may have a light transmittance of greater than or equal to about 85% in a wavelength region of about 400 nm to about 780 nm. The polyolefin 71 may be elongated in a uniaxial direction. The direction may be the length direction of the dichroic dye 72.

The dichroic dye 72 is dispersed in the polyolefin 71 and aligned in the elongation direction of the polyolefin 71. The dichroic dye 72 transmits one perpendicular polarization component out of the two perpendicular polarization components within a predetermined wavelength region. The dichroic dye 72 may be included in an amount of about 0.01 to about 5 parts by weight based on 100 parts by weight of the polyolefin 71. Within this range, sufficient polarization characteristics may be obtained without deteriorating the transmittance of the polarization film. Specifically, the dichroic dye 72 may be included in an amount of about 0.05 to about 1 part by weight based on 100 parts by weight of the polyolefin 71.

The polarization film 110 may have a dichroic ratio of about 2 to about 14 at a maximum absorption wavelength (λₘₐₓ) in a visible ray region. Within this range, the dichroic ratio may specifically be from about 3 to about 10. As used herein, the dichroic ratio is a value obtained by dividing the linear polarization absorption in a direction perpendicular to the axis of the polymer by the polarization absorption in a direction parallel to the polymer. The dichroic ratio may be determined using Equation 1.

DR=Log(1/T_{⊥})/Log(1/T_{//}) [Equation 1]

In Equation 1,

DR is a dichroic ratio of a polarization film,

T_{//} is light transmittance of light entering parallel to the transmissive axis of a polarization film, and

T_{⊥} is light transmittance of light entering perpendicular to the transmissive axis of the polarization film.

The dichroic ratio denotes the degree to which the dichroic dye 72 is aligned in one direction within the polarization film 110. The polarization film 110 has a dichroic ratio within the range in the visible light wavelength region, which leads the dichroic dye 72 to be aligned along the same alignment direction as the polyolefin chains, and thus may improve the polarizing characteristics of the polarization film.

The polarization film 110 may have a polarizing efficiency of greater than or equal to about 80%, and specifically, about 83 to about 99.9%. The polarizing efficiency may be determined using Equation 2.

PE(%)=[(T_{//}−T_{⊥})/(T_{//}+T_{⊥})]^{1/2} [symbol] 100 [Equation 2]

In Equation 2,

PE is the polarizing efficiency,

T_{∥} is light transmittance of the polarization film for light parallel to the transmissive axis of the polarization film, and

T_{⊥} is light transmittance of the polarization film for light perpendicular to the transmissive axis of the polarization film.

The polarizing film 110 may have a relatively thin thickness of less than or equal to about 100 μm, specifically, about 30 μm to about 95 μm. When the polarizing film 70 has a thickness with this range, the polarizing film 70 is relatively thinner in comparison to a polyvinyl alcohol (PVA) polarizing plate requiring a protective layer such as triacetyl cellulose (TAC), and thus may enable formation of a thin display device.

The phase delay layer 120 may be an elongated polymer layer including, for example, a polymer having positive or negative birefringence. The birefringence (Δn) is a difference found by subtracting the refractive index of light propagating perpendicular to an optical axis (n₀) from the refractive index of light propagating parallel to the optical axis (nₑ).

The elongated polymer may include at least one of polystyrene, poly(styrene-co-maleic anhydride), polymaleimide, poly(methacrylic) acid, polyacrylonitrile, poly(methyl methacrylate), cellulose ester, poly(styrene-co-acrylonitrile), poly(styrene-co-maleimide), poly(styrene-co-methacrylic acid), cycloolefin, a cycloolefin copolymer, a derivative thereof, a copolymer thereof, and a mixture thereof, but is not limited thereto.

The phase delay layer 120 may be, for example, a liquid crystal layer including liquid crystals.

The liquid crystals may have a rigid-rod or wide disk shape that is aligned in one direction, and may be, for example, a monomer, an oligomer, and/or a polymer. The liquid crystals may have, for example, positive or negative birefringence. The liquid crystals may be aligned in one direction along the optical axis.

The liquid crystals may be reactive mesogenic liquid crystals, and may have, for example, at least one reactive cross-linking group. The reactive mesogenic liquid crystals may include, for example, at least one of a rod-shaped aromatic derivative having at least one reactive cross-linking group, propylene glycol 1-methyl, propylene glycol 2-acetate, and a compound represented by P1-A1-(Z1-A2)n-P2 (wherein P1 and P2 independently are acrylate, methacrylate, vinyl, vinyloxy, epoxy, or a combination thereof, A1 and A2 independently are 1,4-phenylene, a naphthalene-2,6-diyl group, or a combination thereof, Z1 is a single bond, —COO—, —OCO—, or a combination thereof, and n is 0, 1, or 2), but is not limited thereto.

The phase delay layer 120 may have, for example, reverse wavelength dispersion phase delay. As used herein, the reverse wavelength dispersion phase delay means that retardation of light having a long wavelength is higher than retardation of light having a short wavelength.

The phase delay may be represented by in-plane retardation (Rₑ₀), and in-plane retardation (Rₑ₀) may be determined as follows.

Rₑ₀=(nₓ₀−n_{y0})d₀.

Herein, nₓ₀ is the refractive index in a direction having the highest refractive index in a plane of the phase delay layer 120 (hereinafter referred to as “slow axis”), n_{y0} is a refractive index in a direction having the lowest refractive index in a plane of the phase delay layer 120 (hereinafter referred to as “fast axis”), and d is the thickness of the phase delay layer 120.

The in-plane retardation may be provided within a predetermined range by changing the thickness and/or refractive index at the slow axis and/or the fast axis, and/or the thickness of the phase delay layer 120. According to one embodiment, the in-plane retardation (Rₑ₀) of the phase delay layer 120 for a 550 nm wavelength (hereinafter referred to as “reference wavelength”) may range from about 110 nm to about 160 nm.

In the phase delay layer 120, the retardation of light having a long wavelength is greater than the retardation of light having a short wavelength. In an exemplary embodiment, the in-plane retardation (Rₑ₀) of the phase delay layer 120 for wavelengths of 450 nm, 550 nm, and 650 nm may satisfy the following: Rₑ₀ (450 nm)Rₑ₀ (550 nm)<Rₑ₀ (650 nm) or Rₑ₀ (450 nm)<Rₑ₀ (550 nm)Rₑ₀ (650 nm).

The change in the retardation of the short wavelength as compared to the reference wavelength may be represented by the short wavelength dispersion, which is determined by Rₑ₀ (450 nm)/Rₑ₀ (550 nm). In an exemplary embodiment, the short wavelength dispersion of the phase delay layer 120 may range from about 0.70 to about 0.99.

The change in the retardation of the long wavelength for the reference wavelength may be represented by the long wavelength dispersion, which is determined by Rₑ₀(650 nm)/Rₑ₀(550 nm). In an exemplary embodiment, the long wavelength dispersion of the phase delay layer 120 may range from about 1.01 to about 1.20.

The retardation includes thickness direction retardation (Rₜₕ) in addition to the in-plane retardation (Rₑ₀). The thickness direction retardation (Rₜₕ₀) is generated in a thickness direction of the phase delay layer 120, and the thickness direction retardation (Rₜₕ₀) of the phase delay layer 120 may be represented by the following equation.

Rₜₕ₀={[(nₓ₀+n_{y0})/2]−n_{z0}}d₀.

Herein, nₓ₀ is the refractive index at a slow axis of the phase delay layer 120, n_{y0} is the refractive index at a fast axis of the phase delay layer 120, and n_{z0} is the refractive index in a direction perpendicular to nₓ₀ and n_{y0}. In an exemplary embodiment, the thickness direction retardation (Rₜₕ₀) of the phase delay layer 120 for a reference wavelength may range from about −250 nm to about 250 nm.

The phase delay layer 120 may have a thickness of less than or equal to about 10 μm, specifically, about 2 μm to about 10 μm.

The polarizing film 110 and the phase delay layer 120 are bound by interposing a curable adhesive 115 between the polarizing film 110 and the phase delay layer 120.

The curable adhesive 115 is a liquid at room temperature and is phase-shifted to a solid phase when cured. The curable adhesive 115 is different from a pressure sensitive adhesive (PSA) which is a liquid at room temperature and present as a liquid or semi-solid after curing.

The curable adhesive 115 may be, for example, a photo-curable adhesive or a thermosetting adhesive. The photo-curable adhesive may be, for example, a UV-curable adhesive which is cured by light having a wavelength in the ultraviolet (UV) wavelength region, but is not limited thereto.

In an exemplary embodiment, the curable adhesive 115 may be a composition including a curable resin, a reaction initiator, and an additive, and/or a cured product of the composition.

The curable resin may include, for example, one or more of a (meth)acrylic resin, an urethane resin, a polyisobutylene resin, a styrene butadiene rubber, a polyvinylether resin, an epoxy resin, a melamine resin, a polyester resin, a phenolic resin, a silicon monomer, a derivative thereof, a copolymer thereof, and a mixture thereof, but is not limited thereto. The curable resin may include, for example, one or more of caprolactone acrylate, 1,6-hexanediol diacrylate, trimethylolpropane triacrylate, pentaerythritol triacrylate, lauryl acrylate, urethane acrylate, epoxy acrylate, polyester acrylate, silicon acrylate, and a combination thereof, but is not limited thereto.

The reaction initiator may be a photo-initiator or thermo-initiator, which may be a compound decomposed by light or heat to provide a radical and to initiate a reaction by the radical. The reaction initiator may include, for example, one or more of benzoyl peroxide, acetyl peroxide, dilauroyl peroxide, hydrogen peroxide, potassium persulfate, 2,2′-azobisisobutyronitrile (AIBN), acetophenone, and a combination thereof, but is not limited thereto.

The additive may include, for example, one or more of a cross-linking agent, a reaction promoter, a dispersing agent, and the like, but is not limited thereto.

The curable adhesive 115 may have a thickness of less than or equal to about 5 μm. Specifically, the curable adhesive 115 may have a thickness of about 0.2 μm to about 5 μm, and more specifically, the thickness may be about 0.5 μm to about 3 μm.

The curable adhesive 115 may have a 90° peeling force of greater than or equal to about 20 gram force (gf)/25 millimeters (mm) from the polarizing film, as measured at room temperature. The 90° peeling force is an index for evaluating adherence between the polyolefin film and the curable adhesive 115, and is measured as follows: a polarizing (e.g. polyolefin) film, a curable adhesive 115, and a polymer film are stacked to provide a sample; the sample is cured; and then the polarizing film is folded and pulled up at an angle of 90° relative to the surface of the sample. The 90° peeling force may be from about 20 gf/25 mm to about 1000 gf/25 mm, but is not limited thereto.

The curable adhesive 115 may provide strong adherence with only a relatively thin thickness as compared to the liquid or semi-solid adhesive such as a pressure sensitive adhesive. Accordingly, the thickness of optical film 100 may be reduced, and thus the thickness of the display device employing the optical film 100 may also be reduced.

The curable adhesive 115 may have high surface hardness and a high modulus compared to a liquid or semi-solid phase adhesive (e.g. a pressure sensitive adhesive), and as a result, the durability of the optical film 100 may be increased. In particular, unlike a liquid or semi-solid adhesive, the curable adhesive 115 is rarely deformed at a high temperature, and as a result, the high temperature durability of the optical film 100 may be enhanced.

The curable adhesive 115 has a high tensile modulus compared to a liquid or semi-solid phase adhesive (e.g. pressure sensitive adhesive), and thus rarely generates damage, such as cracks and/or wrinkles, when it is bent or folded. Accordingly, the curable adhesive may reduce deformation in the appearance of the optical film 100, and thus may be effectively used to improve display characteristics of a display device employing the optical film 100, for example, a flexible display device such as a foldable display device or a bendable display device. In an exemplary embodiment, the optical film 100 may have modulus of greater than or equal to about 1800 megapascals (MPa). In another exemplary embodiment, the optical film 100 may have surface hardness of greater than or equal to about 90 Newtons per square millimeter (N/mm²).

The polarizing film 110 may undergo surface treatment to improve adherence with the curable adhesive 115. The surface treatment may include, for example, one or more of corona treatment, plasma treatment, and halogenation treatment, but is not limited thereto.

The optical film 100 may further include a correction layer (not shown) positioned on the phase delay layer 120. The correction layer may be, for example, a color shift resistant layer, but is not limited thereto.

The optical film 100 may further include a light blocking layer (not shown) extended along the edge of the film. The light blocking layer may be formed in a strip along the circumference of the optical film 100, and for example, may be positioned between the polarization film 110 and the phase delay layer 120. The light blocking layer may include an opaque material, for example, a black material. For example, the light blocking layer may be made of a black ink.

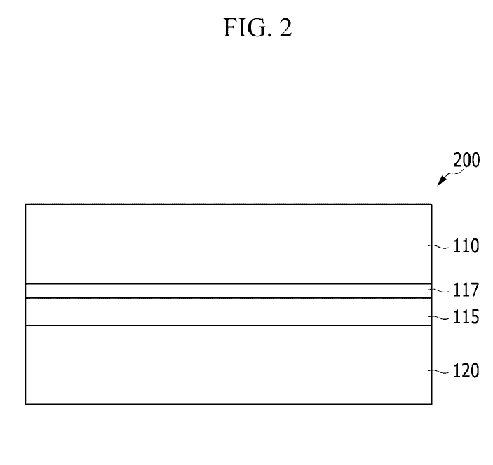

Hereinafter, an exemplary embodiment of an optical film is described with reference to FIG. 2.

FIG. 2 is a schematic view of an exemplary embodiment of a polarization film.

Referring to FIG. 2, an exemplary embodiment of an optical film 200 includes a polarizing film 110, a phase delay layer 120 positioned on the polarizing film 110, and a curable adhesive 115 positioned between the polarizing film 110 and the phase delay layer 120.

The exemplary optical film 200 shown in FIG. 2, further includes an auxiliary layer 117 positioned between the polarizing film 110 and the curable adhesive 115. The auxiliary layer 117 may be an adhesive auxiliary layer to improve adherence between the polarizing film 110 and the curable adhesive 115.

In an exemplary embodiment, the auxiliary layer 117 may include a polyolefin. More specifically, the polyolefin may be a halogenated polyolefin. In an exemplary embodiment, the auxiliary layer 117 may include a chlorinated polyolefin, more specifically, a chlorinated polypropylene.

In an exemplary embodiment, the auxiliary layer 117 may be formed by preparing a composition including a halogenated polyolefin in a solvent or a dispersive medium in a predetermined concentration, coating the composition, and then drying the same. The halogenated polyolefin may be present in an amount of about 0.1 to about 80 weight percent (wt %), more specifically about 1 to about 50 wt %, or even more specifically, about 5 to about 30 wt % based on the total amount of the composition.

In an exemplary embodiment, the auxiliary layer 117 may have a thickness of less than or equal to about 1 μm, for example about 10 nm to about 1 μm.

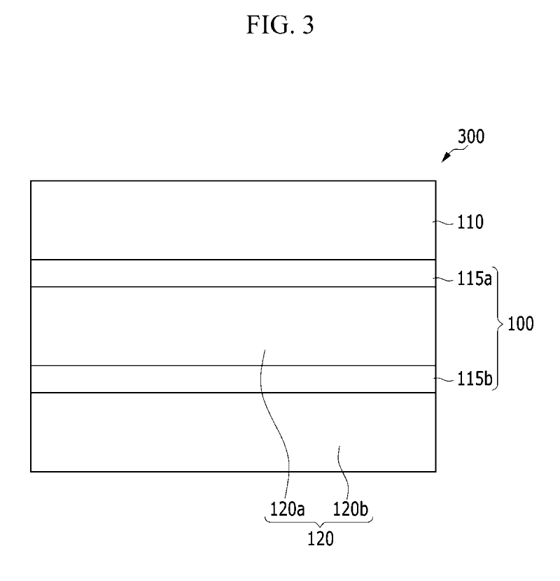

Hereinafter, an exemplary embodiment of an optical film according is described with reference to FIG. 3.

FIG. 3 is a schematic cross-sectional view of an optical film according to another embodiment.

Referring to FIG. 3, an exemplary embodiment of an optical film 300 includes a polarizing film 110, a first phase delay layer 120a, a second phase delay layer 120b, a curable adhesive 115a positioned between the polarizing film 110 and the first phase delay layer 120a, and a curable adhesive 115b positioned between the first phase delay layer 120a and the second phase delay layer 120b.

The first phase delay layer 120a and the second phase delay layer 120b may have different in-plane retardation from each other. In an exemplary embodiment, one of the first phase delay layer 120a and the second phase delay layer 120b may have an in-plane retardation of about 230 nm to about 300 nm for the reference wavelength (550 nm), and the other one may have an in-plane retardation of about 110 nm to about 160 nm for the reference wavelength. For example, the first phase delay layer 120a may have in-plane retardation from about 230 nm to about 300 nm for the reference wavelength, and the second phase delay layer 120b may have in-plane retardation from about 110 nm to about 160 nm for the reference wavelength.

In an exemplary embodiment, one of the first phase delay layer 120a and the second phase delay layer 120b may be a λ/2 phase delay layer, and the other may be a λ/4 phase delay layer. More specifically, the first phase delay layer 120a may be a λ/2 phase delay layer and the second phase delay layer 120b may be a λ/4 phase delay layer.

The first phase delay layer 120a and the second phase delay layer 120b may independently be an elongated polymer layer including a polymer having positive or negative birefringence. The polymer may include, for example, one or more of polystyrene, poly(styrene-co-maleic anhydride), polymaleimide, poly(meth)acrylic acid, polyacrylonitrile, polymethyl(meth)acrylate, cellulose ester, poly(styrene-co-acrylonitrile), poly(styrene-co-maleimide), poly(styrene-co-methacrylic acid), cycloolefin, a cycloolefin copolymer, a derivative thereof, a copolymer thereof, and a mixture thereof, but is not limited thereto.

In one exemplary embodiment, each of the first phase delay layer 120a and the second phase delay layer 120b may include a polymer having positive birefringence.

In another exemplary embodiment, each of the first phase delay layer 120a and the second phase delay layer 120b may include a polymer having negative birefringence.

In yet another exemplary embodiment, one of the first phase delay layer 120a and the second phase delay layer 120b may include a polymer having positive birefringence, and the other one may include a polymer having negative birefringence.

The first phase delay layer 120a and the second phase delay layer 120b may each be an anisotropic liquid crystal layer including liquid crystal molecules, and the first phase delay layer 120a and the second phase delay layer 120b may independently have positive or negative birefringence.

In an exemplary embodiment, the first phase delay layer 120a and second phase delay layer 120b may each have a forward wavelength dispersion phase delay, and a combination of the first phase delay layer 120a and the second phase delay layer 120b may have a reverse wavelength dispersion phase delay. The forward wavelength dispersion phase delay has a higher retardation of light having a short wavelength than retardation of light having a long wavelength, and the reverse wavelength dispersion phase delay has a higher retardation of light having a long wavelength than retardation of light having a short wavelength.

The phase delay may be represented by in-plane retardation. The in-plane retardation (Rₑ₁) of the first phase delay layer 120a may be represented by Rₑ₁=(nₓ₁−n_{y1})d₁, in-plane retardation (Rₑ₂) of the second phase delay layer 120b may be represented by Rₑ₂=(nₓ₂−n_{y2})d₂, and the entire in-plane retardation (Rₑ₀) of the phase delay layer 120 may be represented by Rₑ₀=(nₓ₀−n_{y0})d₀. Herein, nₓ₁ is the refractive index at the slow axis of the first phase delay layer 120a, n_{y1} is the refractive index at the fast axis of the first phase delay layer 120a, d₁ is the thickness of the first phase delay layer 120a, nₓ₂ is the refractive index at a slow axis of the second phase delay layer 120b, n_{y2} is the refractive index at a fast axis of the second phase delay layer 120b, d₂ is the thickness of the second phase delay layer 120b, nₓ₀ is the refractive index at a slow axis of the phase delay layer 120, n_{y0} is the refractive index at a fast axis of the phase delay layer 120, and d₀ is the thickness of the phase delay layer 120.

Accordingly, the in-plane retardation (Rₑ₁ and Rₑ₂) may be provided within a predetermined range by changing the refractive indices at the slow axis and/or the fast axis, and/or by changing the thickness of the first phase delay layer 120a and the second phase delay layer 120b.

In an exemplary embodiment, in-plane retardation (Rₑ₁) for a reference wavelength of the first phase delay layer 120a may be from about 230 nm to about 300 nm, in-plane retardation (Rₑ₂) for a reference wavelength of the second phase delay layer 120b may be from about 110 nm to about 160 nm. Further, the entire in-plane retardation (Rₑ₀) of the phase delay layer 120, for incident light having a reference wavelength, may be the difference between the in-plane retardation (Rₑ₁) of the first phase delay layer 120a and the in-plane retardation (Rₑ₂) of the second phase delay layer 120b. In an exemplary embodiment, the in-plane retardation (Rₑ₀) of the phase delay layer 120 for a reference wavelength may range from about 110 nm to about 160 nm.

In the first phase delay layer 120a and the second phase delay layer 120b, the retardation of light having a short wavelength may be higher than the retardation of light having a long wavelength. In an exemplary embodiment, for the wavelengths of 450 nm, 550 nm, and 650 nm, the in-plane retardation (Rₑ₁) of the first phase delay layer 120a may satisfy Rₑ₁ (450 nm)≧Rₑ₁ (550 nm)>Rₑ₁ (650 nm) or Rₑ₁ (450 nm)>Rₑ₁ (550 nm)≧Rₑ₁ (650 nm), and the in-plane retardation (Rₑ₂) of the second phase delay layer 120b may satisfy Rₑ₂ (450 nm)>Rₑ₂ (550 nm)>Rₑ₂ (650 nm).

The combination of the first phase delay layer 120a and the second phase delay layer 120b may have higher retardation of light having a long wavelength than the retardation of light having a short wavelength. In an exemplary embodiment, the in-plane retardation (Rₑ₀) of the first phase delay layer 120a and the second phase delay layer 120b at 450 nm, 550 nm, and 650 nm wavelengths may satisfy Rₑ₀(450 nm)≦Rₑ₀(550 nm)<Rₑ₀(650 nm) or Rₑ₀(450 nm)<Rₑ₀(550 nm)≦Rₑ₀(650 nm).

The change in the retardation of the short wavelength with the reference wavelength may be represented by short wavelength dispersion. The short wavelength dispersion of the first phase delay layer 120a may be represented by Rₑ₁ (450 nm)/Rₑ₁ (550 nm), and the short wavelength dispersion of the second phase delay layer 120b may be represented by Rₑ₂ (450 nm)/Rₑ₂ (550 nm). In an exemplary embodiment, the short wavelength dispersion of the first phase delay layer 120a and the second phase delay layer 120b may independently be about 1.1 to about 1.2, and the entire short wavelength dispersion of the first phase delay layer 120a and the second phase delay layer 120b may range from about 0.70 to about 0.99.

The change in the retardation of the long wavelength with the reference wavelength may be represented by the long wavelength dispersion. The long wavelength dispersion of the first phase delay layer 120a may be represented by Rₑ₁ (650 nm)/Rₑ₁ (550 nm), and the long wavelength dispersion of the second phase delay layer 120b may be represented by Rₑ₂ (650 nm)/Rₑ₂ (550 nm). In an exemplary embodiment, the long wavelength dispersion of the first phase delay layer 120a and the second phase delay layer 120b may independently be about 0.9 to about 1.0, and the entire long wavelength dispersion of the first phase delay layer 120a and the second phase delay layer 120b may range from about 1.01 to about 1.20.

On the other hand, the thickness direction retardation (Rₜₕ₁) of the first phase delay layer 120a may be represented by Rₜₕ₁={[(nₓ₁+n_{y1})/2]−n_{z1}}d₁, the thickness direction retardation (Rₜₕ₂) of the second phase delay layer 120b may be represented by Rₜₕ₂={[(nₓ₂+n_{y2})/2]−n_{z2}}d₂, and the thickness direction retardation (Rₜₕ₀) of the combined first phase delay layer 120a and the second phase delay layer 120b may be represented by Rₜₕ₀={[(nₓ₀+n_{y0})/2]−n_{z0}}d₀. Herein, nₓ₁ is the refractive index at a slow axis of the first phase delay layer 120a, n_{y1} is the refractive index at a fast axis of the first phase delay layer 120a, n_{z1} is the refractive index in a direction perpendicular to nₓ₁ and n_{y1}, nₓ₂ is the refractive index at a slow axis of the second phase delay layer 120b, n_{y2} is the refractive index at a fast axis of the second phase delay layer 120b, n_{z2} is the refractive index in a direction perpendicular to nₓ₂ and n_{y2}, nₓ₀ is the refractive index at a slow axis of the phase delay layer 120, n_{y0} is the refractive index at a fast axis of the phase delay layer 120, and n_{z0} is the refractive index in a direction perpendicular to nₓ₀ and n_{y0}.

The thickness direction retardation (Rₜₕ₀) of the phase delay layer 120 may be the sum of the thickness direction retardation (Rₜₕ₁) of the first phase delay layer 120a and the thickness direction retardation (Rₜₕ₂) of the second phase delay layer 120b.

An angle between a slow axis of the first phase delay layer 120a and a slow axis of the second phase delay layer 120b may be from about 50° to about 70°. More specifically, the angle may be, for example, about 55° to about 65°, even more specifically about 52.5° to about 62.5°, or yet even more specifically, about 60°. For example, the slow axis of the first phase delay layer 120a may be about 15°, the slow axis of the second phase delay layer 120b may be about 75°, and an angle therebetween may be about 60°.

In addition, the first phase delay layer 120a and the second phase delay layer 120b may have respective refractive indices satisfying the following Relationship Equation 1A or 1B.

nₓ>n_{y}=n_{z} [Relationship Equation 1A]

nₓ<n_{y}=n_{z} [Relationship Equation 1B]

In the Relationship Equations 1A and 1B,

nₓ is a refractive index of the first phase delay layer 120a and the second phase delay layer 120b at a slow axis, n_{y} is a refractive index of the first phase delay layer 120a and the second phase delay layer 120b at a fast axis, and nₓ is a refractive index in a direction perpendicular to nₓ and n_{y}.

In an exemplary embodiment, each of the first phase delay layer 120a and the second phase delay layer 120b may have a refractive index satisfying Relationship Equation 1A.

In an exemplary embodiment, each the first phase delay layer 120a and the second phase delay layer 120b may have a refractive index satisfying Relationship Equation 1B.

In an exemplary embodiment, the first phase delay layer 120a may have a refractive index satisfying Relationship Equation 1A, and the second phase delay layer 120b may have a refractive index satisfying Relationship Equation 1B.

In an exemplary embodiment, the first phase delay layer 120a may have a refractive index satisfying Relationship Equation 1B, and the second phase delay layer 120b may have a refractive index satisfying Relationship Equation 1A.

One of the first phase delay layer 120a and the second phase delay layer 120b may be an elongated polymer layer including a polymer having positive or negative birefringence, and the other one may be a liquid crystal layer having positive or negative birefringence.

Each of the first phase delay layer 120a and the second phase delay layer 120b may have a thickness of less than or equal to about 5 μm.

The polarizing film 110 and the first phase delay layer 120a are bound together by interposing the curable adhesive 115a therebetween. The first phase delay layer 120a and the second phase delay layer 120b are bound together by interposing the curable adhesive 115b therebetween.

The curable adhesives 115a and 115b are in a liquid phase at room temperature and are shifted to a solid phase during the curing process. The curable adhesive is different from a pressure sensitive adhesive which is present in a liquid phase at room temperature and present in a liquid or semi-solid phase after the curing process.

The curable adhesives 115a and 115b may be a photo-curable adhesive or a thermosetting adhesive, but are not limited thereto. More specifically, the curable adhesive may be a UV curable adhesive. The curable adhesives 115a and 115b may be the same as, or different from, each other.

The curable adhesive 115a and 115b may each have a thickness of less than or equal to about 5 μm. More specifically, the curable adhesive 115a and 115b may each have a thickness of about 0.2 μm to 5 μm, and even more specifically, the thickness may be from about 0.5 μm to about 3 μm.

The curable adhesive 115a and 115b may have a 90° peeling force of greater than or equal to about 20 gf/25 mm at room temperature from the polarizing (e.g. polyolefin) film. The 90° peeling force is an index evaluating adherence as follows: a polarizing film (e.g. polyolefin film), a curable adhesive 115, and a polymer film are sequentially stacked to provide a sample; the sample is cured; and then the polymer film is folded and pulled up at an angle of 90° relative to the surface of the sample to evaluate adherence between the polyolefin film and the curable adhesive 115. The peeling force may be about 20 gf/25 mm to about 1000 gf/25 mm, but is not limited thereto.

The curable adhesives 115a and 115b, having a relatively thin thickness, may provide strong adherence when compared to a liquid or semi-solid adhesive such as a pressure sensitive adhesive. Accordingly, use of the curable adhesives 1151 and 115b may reduce the thickness of optical film 300, and thus the display device employing the optical film 300 may have an overall reduced thickness as well.

The curable adhesives 115a and 115b may have higher surface hardness and tensile modulus compared to a liquid or semi-solid adhesive such as a pressure sensitive adhesive. As a result, the durability of the optical film 300 may be enhanced. In particular, unlike a liquid or semi-solid adhesive, the curable adhesives 115a and 115b are rarely deformed at a high temperature so the durability of the optical film 300 at a high temperature may be enhanced.

The curable adhesives 115a and 115b have a high modulus compared to a liquid or semi-solid pressure sensitive adhesive, and thus damage such as cracks and/or wrinkles rarely occur when bent or folded. Accordingly, the curable adhesives may reduce deformation in the appearance of the optical film 300, and thus may be effectively applied to a flexible display device employing the optical film 300 and may improve the display characteristics of the display device. In an exemplary embodiment, the optical film 300 may have a modulus of greater than equal to about 1800 MPa and surface hardness of greater than or equal to about 90 N/mm².

The polarizing film 110 may undergo surface treatment to improve adherence with the curable adhesive 115a. The surface treatment may include, for example, one or more of a corona treatment, a plasma treatment, and a halogenation treatment, but is not limited thereto.

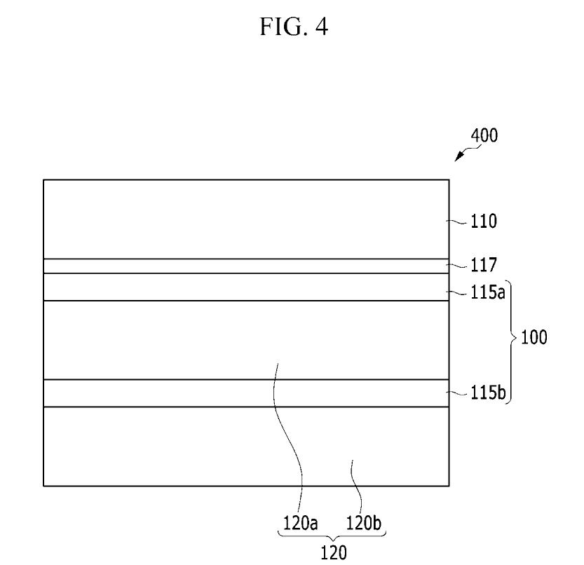

Hereinafter, another exemplary embodiment of an optical film is described referring to FIG. 4.

FIG. 4 is a schematic cross-sectional view of an exemplary embodiment of an optical film.

Referring to FIG. 4, an optical film 400 includes a polarizing film 110, a first phase delay layer 120a, a second phase delay layer 120b, a curable adhesive 115a positioned between the polarizing film 110 and the first phase delay layer 120a, and a curable adhesive 115b positioned between the first phase delay layer 120a and the second phase delay layer 120b.

The exemplary optical film 400 further includes an auxiliary layer 117 positioned between the polarizing film 110 and the curable adhesive 115a. The auxiliary layer 117 may be an adhesive auxiliary layer to improve adherence between the polarizing film 110 and the curable adhesive 115a.

The auxiliary layer 117 may include. a polyolefin. More specifically, the polyolefin may be a halogenated polyolefin. In an exemplary embodiment, the auxiliary layer 117 may include a chlorinated polyolefin, more specifically, a chlorinated polypropylene. The auxiliary layer 117 may be formed by preparing a composition including a halogenated polyolefin in a solvent or a dispersive medium in a predetermined concentration, coating the composition, and then drying the same. The halogenated polyolefin may be present in an amount of about 0.1 to about 80 wt %, more specifically, about 1 to about 50 wt %, or even more specifically, about 5 to about 30 wt % based on the total amount of the composition.

In an exemplary embodiment, The auxiliary layer 117 may have a thickness of less than or equal to about 1 μm, more specifically, about 10 nm to about 1 μm.

Hereinafter, the method of manufacturing an exemplary embodiment of the optical film is described with reference to FIGS. 1 to 4 and FIG. 6.

In an exemplary embodiment, the manufacturing method includes preparing a polarizing film 110, preparing a phase delay layer 120, and binding the polarizing film 110 and the phase delay layer 120 using a curable adhesive 115.

The preparing of the polarizing film 110 may include melt-mixing a composition including a polyolefin 71 and a dichroic dye 72, introducing the melt blend into a mold, pressing the mold to provide a sheet, and elongating the sheet in a uniaxial direction.

The polyolefin 71 and the dichroic dye 72 are each included as a solid form such as powder, and are melt-mixed at a temperature of greater than or equal to the melting point (Tm) of the polyolefin 71 and then elongated to provide a polarizing film 110.

The melt-mixing of the composition may be performed at a temperature of, for example, less than or equal to about 300° C., specifically, at a temperature of about 130 to about 300° C. The providing of a sheet may be performed by introducing the melt blend into the mold and pressing the same using a high pressure machine or by discharging the same into a chill roll through a T-die. The step of elongating in a uniaxial direction may be performed by elongating the sheet at a temperature of about 25 to about 200° C. until the sheet has reached an elongation percentage of about 400% to about 1000%. The elongation percentage refers to how much the sheet is stretched after performing the step of elongating in a uniaxial direction and is measured by comparing the length of the sheet after elongation to the length of the sheet before the elongation.

One side of the polarizing film 110 may undergo the surface treatment, for example, one or more of a corona treatment, a plasma treatment, and a halogenation treatment.

One side of the polarizing film 110 may be coated with an auxiliary agent to improve adherence. In an exemplary embodiment, the polarizing film 110 may be coated with an auxiliary solution including a halogenated polyolefin and dried to provide an auxiliary layer 117. The auxiliary solution may be prepared, for example, providing a composition including a halogenated polyolefin in a solvent or a dispersive medium at a predetermined concentration, coating the composition on the polarizing film 110, and drying the same. The halogenated polyolefin may be present in an amount of about 0.1 to about 80 wt %, more specifically, about 1 to about 50 wt %, or even more specifically, about 5 to about 30 wt % based on the total amount of the composition, without limitation. The halogenated polyolefin may be, for example, a chlorinated polyolefin, more specifically, a chlorinated polypropylene.

The phase delay layer 120 may be prepared as a film including a polymer or liquid crystals.

In an exemplary embodiment, a polymer solution may be coated on a substrate and cured by photo-irradiation. The substrate may be, for example, a triacetyl cellulose (TAC) film, but is not limited thereto. The polymer solution may be prepared by mixing a polymer in a solvent such as toluene, xylene, or cyclo-hexanone.

In an exemplary embodiment, a liquid crystal solution is coated on a substrate and cured by photo-irradiation. The substrate may be, for example, a triacetyl cellulose (TAC) film, but is not limited thereto. The liquid crystal solution may be prepared by, for example, mixing liquid crystal in a solvent such as toluene, xylene, and cyclo-hexanone.

Subsequently, a curable adhesive 115 is applied on one side of the polarizing film 110 and/or one side of the phase delay layer 120. One side of the polarizing film 110 may be, for example, a region where the surface treatment is performed or a region applied with the auxiliary layer 117.

In an exemplary embodiment, when the curable adhesive 115 is applied on one side of the polarizing film 110, the phase delay layer 120 may be prepared by transferring it from a substrate to the polarizing film 110 applied with the curable adhesive 115. However, the method is not limited to the transferring method, and instead the phase delay layer 120 may be formed using a method such as, for example, roll-to-roll, spin coating, and the like, but is not limited thereto.

When the phase delay layer 120 includes a first phase delay layer 120a and a second phase delay layer 120b, the first phase delay layer 120a and the second phase delay layer 120b are each prepared on a substrate in a film form, or may be sequentially formed on one substrate.

When the phase delay layer 120 includes a first phase delay layer 120a and a second phase delay layer 120b, the phase delay layer 120 may be prepared by transferring the first phase delay layer 120a onto the polarizing film 110 applied with a curable adhesive 115a, applying a curable adhesive 115b on the other side of the first phase delay layer 120a, and transferring the second phase delay layer 120b to the side of the first phase delay layer 120a applied with the curable adhesive 115b.

The optical film may be applied to various types of display devices.

In an exemplary embodiment, a display device according to one embodiment includes a display panel and an optical film positioned on one side of the display panel. The display panel may be a liquid crystal panel or an organic light emitting panel, but is not limited thereto.

Hereinafter, an organic light emitting display is described as one example of a display device.

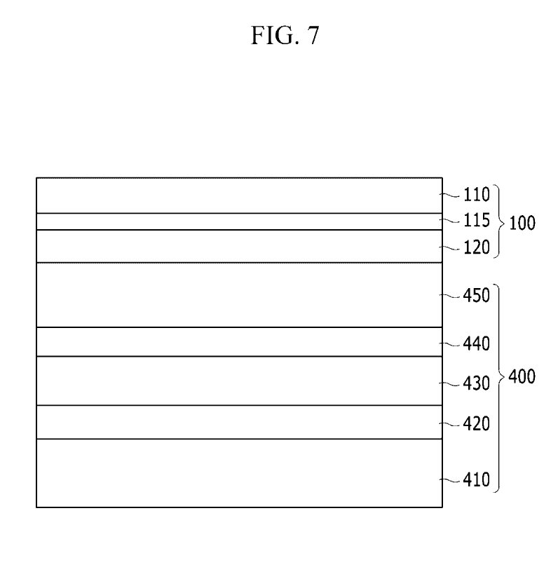

FIG. 7 is a cross-sectional view showing an exemplary embodiment of an organic light emitting display.

Referring to FIG. 7, the exemplary organic light emitting display includes an organic light emitting panel 400 and an optical film 100 positioned on one side of the organic light emitting diode panel 400.

The organic light emitting diode panel 400 may include a base substrate 410, a lower electrode 420, an organic emission layer 430, an upper electrode 440, and an encapsulation substrate 450.

The base substrate 410 may be made of glass or plastic.

At least one of the lower electrode 420 and the upper electrode 440 may be an anode, and the other one may be a cathode. The anode is an electrode injected with holes, and may be made of a transparent conductive material having a high work function to transmit the emitted light to the outside, for example, indium tin oxide (ITO) or indium zinc oxide (IZO). The cathode is an electrode injected with electrons, and may be made of a conductive material having a low work function and not affecting the organic material. from the conductive material may include, one or more of aluminum (Al), calcium (Ca), and barium (Ba).

The organic emission layer 430 includes an organic material which may emit light when a voltage is applied to the lower electrode 420 and the upper electrode 440.

An auxiliary layer (not shown) may be further provided between the lower electrode 420 and the organic emission layer 430 and between the upper electrode 440 and the organic emission layer 430. The auxiliary layer is used to balance electrons and holes, and may include a hole transport layer, a hole injection layer (HIL), an electron injection layer (EIL), and an electron transporting layer.

The encapsulation substrate 450 may be made of glass, metal, or a polymer, and may seal the lower electrode 420, the organic emission layer 430, and the upper electrode 440 to prevent moisture penetration and/or oxygen inflow from the outside.

The organic light emitting panel 400 may be a flexible panel.

The optical film 100 may be disposed on the light-emitting side. For example, in the case of a bottom emission structure emitting light at the side of the base substrate 410, the optical film 100 may be disposed on the exterior side of the base substrate 410. Alternatively, in the case of a top emission structure emitting light at the side of the encapsulation substrate 450, the optical film 100 may be disposed on the exterior side of the encapsulation substrate 450.

The optical film 100 includes the polarization film 110 that is self-integrated and formed of a melt blend of a polyolefin and a dichroic dye, the one- or two-layered phase delay layer 120, and the curable adhesive 115 as described previously. The polarization film 110 and the phase delay layer 120 are respectively the same as previously described, and may prevent a display device from having a deterioration in visibility caused by light inflowing from outside of the display device which passes through the polarization film 110 and is reflected by a metal component present in the organic light emitting panel 400. Accordingly, display characteristics of the organic light emitting display may be improved.

Although the present embodiment describes an example of an organic light emitting display employing the exemplary optical film 100, the exemplary optical films 200, 300, and 400 may also be applied to an organic light emitting display in the same manner.

Hereinafter, a liquid crystal display (LCD) is described as one example of the display device.

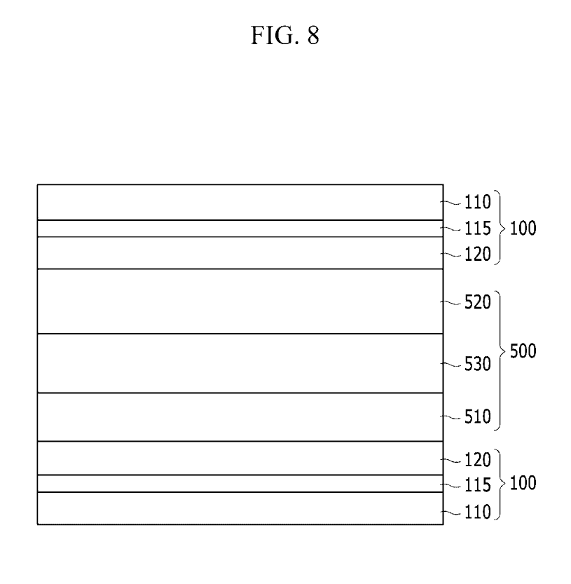

FIG. 8 is a cross-sectional view schematically showing an exemplary embodiment of a liquid crystal display.

Referring to FIG. 8, the liquid crystal display (LCD) according to one embodiment includes a liquid crystal display panel 500, and an optical film 100 positioned on one side of the liquid crystal panel 500.

The liquid crystal panel 500 may be a twist nematic (TN) mode panel, a vertical alignment (PVA) mode panel, an in-plane switching (IPS) mode panel, an optically compensated bend (OCB) mode panel, or the like.

The liquid crystal panel 500 may include a first display panel 510, a second display panel 520, and a liquid crystal layer 530 interposed between the first display panel 510 and the second display panel 520.

The first display panel 510 may include, for example, a thin film transistor (not shown) formed on a substrate (not shown) and a first electric field generating electrode (not shown) connected to the same. The second display panel 520 may include, for example, a color filter (not shown) formed on a substrate (not shown) and a second electric field generating electrode (not shown). However, the display panels are not limited thereto, and the color filter may be included in the first display panel 510, while the first electric field generating electrode and the second electric field generating electrode may be disposed on the first display panel 510 together therewith.

The liquid crystal layer 530 may include a plurality of liquid crystal molecules. The liquid crystal molecules may have positive or negative dielectric anisotropy. In the case where the liquid crystal molecules have positive dielectric anisotropy, the major axes thereof may be aligned to be substantially parallel to the surface of the first display panel 510 and the second display panel 520 when not applying (e.g. in the absence of) an electric field, and the major axes may be aligned to be substantially perpendicular to the surface of the first display panel 510 and second display panel 520 when applying (e.g. in the presence of) an electric field. On the other hand, in the case of the liquid crystal molecules having negative dielectric anisotropy, the major axes may be aligned to be substantially perpendicular to the surface of the first display panel 510 and the second display panel 520 when not applying an electric field, and the major axes may be aligned to be substantially parallel to the surface of the first display panel 510 and the second display panel 520 when applying an electric field.

The liquid crystal panel 500 may be a flexible panel.

The optical film 100 may be disposed on the outside of the liquid crystal panel 500. Although the optical film 100 is shown to be provided on both the lower part and the upper part of the liquid crystal panel 500 in the drawing, it is not limited thereto, and it may be formed on only one of the lower part and the upper part of the liquid crystal panel 500.

The optical film 100 includes the polarization film 110 that is self-integrated and formed of a melt blend of a polymer resin and a dichroic dye, and the phase delay layer 120 is a one- or two-layered liquid crystal anisotropic layer as described previously.

Although the present embodiment describes only one example of a display device employing the exemplary optical film 100, the exemplary optical films 200, 300, and 400 may also be applied to a display device in the same manner.

Hereinafter, the present disclosure is illustrated in more detail with reference to the examples. However, these examples are exemplary, and the present disclosure is not limited thereto.

### Preparation of Polarizing Film

### Preparation Example 1

A dichroic dye represented by the following Chemical Formulae 1a to 1d, is mixed in an amount of 1 part by weight based on 100 parts by weight of a polyolefin resin, where the polyolefin resin includes 60 parts by weight of polypropylene (HU300, manufactured by Samsung Total) mixed with 40 parts by weight of a polypropylene-ethylene copolymer (RJ581, manufactured by Samsung Total). The amount of each dichroic dye is as follows: 0.200 parts by weight of a dichroic dye represented by Chemical Formula 1a (yellow, λₘₐₓ=385 nm, dichroic ratio=7.0), 0.228 parts by weight of a dichroic dye represented by Chemical Formula 1b (yellow, λₘₐₓ=455 nm, dichroic ratio=6.5), 0.286 parts by weight of a dichroic dye represented by Chemical Formula 1c (red, λₘₐₓ=555 nm, dichroic ratio=5.1), and 0.286 parts by weight of a dichroic dye represented by Chemical Formula 1d (blue, λₘₐₓ=600 nm, dichroic ratio=4.5).

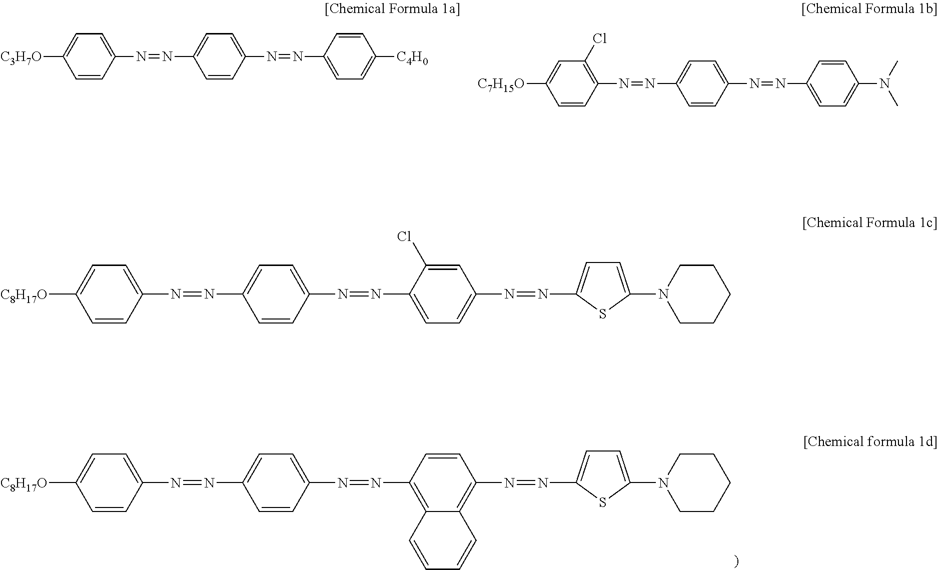

The mixture is melt-mixed using an extruder (Process 11 parallel twin-screw extruder, manufactured by ThermoFisher) at a temperature of 200° C. Subsequently, the melted mixture is filmed using an extruder (cast film extrusion line manufactured by Collin) to provide a sheet. Subsequently, the sheet is elongated 8 times in a uniaxial direction (using a tension tester, manufactured by Instron) to provide a polarizing film.

### Preparation of UV-Curable Adhesive

### Preparation Example 2

60 parts by weight of a cycloaliphatic epoxy (2021 P, manufactured by Daicel), 40 parts by weight of 4-hydroxy butyl acrylate (manufactured by Osaka organic (JAPAN)), and 4 parts by weight of a light radical polymerization initiator triarylsulfonium salt (CPI-100P, manufactured by Sanapro) are blended to provide an adhesive.

### Preparation of Adhesive

### Preparation Example 3

60 parts by weight of butyl acrylate, 38 parts by weight of methyl methacrylate, 2 parts by weight of butyl methacrylate, and 0.2 parts by weight of 2,2′-azobis-isobutyronitrile, are added to 100 parts by weight of ethyl acetate in a 3-neck flask mounted with a cooler, an agitator, and a thermometer, and nitrogen is sufficiently substituted therein. The solution is reacted at 60° C. for 6 hours while agitating under the nitrogen atmosphere to provide an acryl polymer solution.

A xylene diisocyanate tri-reactivity additive (TD-75, manufactured by Soken Chemical & Engineering Co., Ltd.) is added as a solid base at 0.18 parts by weight based on 100 parts by weight of the acryl polymer solution to provide a soft adhesive (soft-type PSA).

Each obtained soft adhesive is coated on a polyester release film (thickness: 38 μm), dried and heat-treated at 105° C. for 5 min to volatilize the solvent to provide an adhesion layer having a thickness of 7 μm on the release film.

### Preparation Example 4

95 parts by weight of 2-ethyl hexyl acrylate, 5 parts by weight of acrylic acid, and 350 parts by weight of acetone are added in a polymerization reactor having a polymerization bath, an agitator, a thermometer, a reflux cooler, and a nitrogen introduction tube. The polymerization reactor is heated to 80° C., 0.05 parts by weight of 2,2′-azobis-isobutyronitrile are added, and the mixture is reacted for 2 h. An additional 0.05 parts by weight of 2,2-azobis isobutyronitrile is added to the solution and then reacted for 5 h. After completing the reaction, the polymerization reactor is cooled and combined with 100 parts by weight of ethyl acetate to provide an acryl-based polymer solution and to provide a hard-type adhesive (hard-type PSA).

The obtained hard-type adhesive is used to form an adhesive layer on a polyester release film as described in Preparation Example 3.

### Sample Preparation for Evaluating Peeling Force of Curable Adhesive

### Example 1

The UV-curable adhesive according to Preparation Example 2 is coated between the polarizing film according to Preparation Example 1 and a polyethylene terephthalate (PET) film having a thickness of 100 μm, and they are lamination-joined and then irradiated with ultraviolet (UV) light at 500 millijoule per square centimeter (mJ/cm²) to provide Sample 1.

### Example 2

An auxiliary solution including chlorinated polyolefin (Superchlon 2319S, Nippon Paper Co.) in toluene at a concentration of 5 wt %, is bar-coated on the polarizing film of Preparation Example 1 and dried in an oven at 85° C. to provide an auxiliary layer. Subsequently, a UV-curable adhesive according to Preparation Example 2 is coated between the polyethylene terephthalate (PET) film and the polarizing film formed with the auxiliary layer, and lamination-joined and then irradiated with ultraviolet (UV) light at 500 mJ/cm² to provide Sample 2.

### Example 3

Sample 3 is prepared in accordance with the same procedure described in Example 2, except that the auxiliary layer is prepared using the auxiliary solution including chlorinated polyolefin (Superchlon 2319S, Nippon Paper Co.) in toluene in at a concentration of 10 wt %.

### Example 4

Sample 4 is prepared in accordance with the same procedure described in Example 2, except that the auxiliary layer is formed using the auxiliary solution including chlorinated polyolefin (Superchlon 2319S, Nippon Paper Co.) in toluene in at a concentration of 20 wt %.

### Evaluation 1: Peeling Force Evaluation of Curable Adhesive

The polyethylene terephthalate (PET) film is folded and pulled up at an angle of 90° to evaluate the peeling force of the polarizing film and the UV-curable adhesive.

The peeling force test results are shown in Table 1.

TABLE 1

| | Peeling Force (gf/25 mm) |
|---|---|
| Example 1 | 88 |
| Example 2 | 164 |
| Example 3 | 352 |
| Example 4 | 383 |

Referring to Table 1, it is confirmed that the samples according to Examples 1 to 4 have excellent peeling force, and that all of them have a peeling force of greater than or equal to about 20 gf/25 mm at room temperature. In particular, it is confirmed that the samples of Examples 2 to 4 employing the auxiliary layer, have excellent peeling force. It is also confirmed that the peeling force is improved as the auxiliary layer includes a higher amount of chlorinated polyolefin.

### Preparation of Optical Film

### Example 5

The polarizing film according to Preparation Example 1 and a λ/2 phase delay layer (MR-2, Dai Nippon Printing Co., Ltd.) are disposed to face each other and coated with the UV-curable adhesive of Preparation Example 2 therebetween, and lamination-joined. The optical characteristics of the λ/2 phase delay layer are shown in Table 2 below. Subsequently, the UV-curable adhesive is irradiated with ultraviolet (UV) light at 500 mJ/cm² to provide an optical film. The PET film supporting the λ/2 phase delay layer is then removed, and then a λ/2 phase delay layer and a λ/4 phase delay layer (MR-4, Dai Nippon Printing Co., Ltd) are disposed to face each other and coated with the UV-curable adhesive of Preparation Example 2 therebetween, and lamination-joined. The optical characteristics of the λ/2 phase delay layer+λ/4 phase delay layer are shown in Table 2 below. Subsequently, the UV-curable adhesive is irradiated with ultraviolet (UV) light at 500 mJ/cm² to provide an optical film.

The polarizing film has an optical axis of 0°, the λ/2 phase delay layer has a slow axis of 15°, the λ/4 phase delay layer has a slow axis of 75°, and the optical film has a thickness of about 28 μm.

TABLE 2

| | In-plane | | | Thickness | |
|---|---|---|---|---|---|
| | retar- | | | direction | |
| | dation | Wavelength dispersion | | phase | Thick- |
| | (Rₑ) | Rₑ 450 nm/Rₑ | Rₑ 650 nm/Rₑ | difference | ness |
| | Rₑ 550 nm | 550 nm | 550 nm | (Rₜₕ) | (μm) |
| λ/2 | 240 | 1.12 | 0.95 | 110 | 2 |
| λ/4 | 120 | 1.08 | 0.96 | −56 | 1 |
| λ/2 + | 136 | 0.80 | 1.08 | 54 | 3 |
| λ/4 | | | | | |

### Example 6

An optical film is prepared in accordance with the same procedure described in Example 5, except that an auxiliary solution including chlorinated polyolefin (Superchlon 2319S, Nippon Paper Co.) in toluene at a concentration of 10 wt % is bar-coated on one side of the polarizing film of Preparation Example 1 and then dried to further provide an auxiliary layer.

### Comparative Example 1

The soft adhesive layer according to Preparation Example 3 is lamination-joined to the polarizing film of Preparation Example 1 without including the UV-curable adhesive according to Preparation Example 2, and then the polyester release film of the adhesive layer is removed. Subsequently, the polarizing film is disposed to face the λ/2 phase delay layer (MR-2, Dai Nippon Printing Co., Ltd) and lamination-joined to provide an optical film. The PET film supporting the λ/2 phase delay layer is then removed and transferred to the phase delay layer, the soft adhesive layer of Preparation Example 3 is lamination-joined, and then the release polyester film of the adhesive layer is removed. Subsequently, the λ/2 phase delay layer and the λ/4 phase delay layer (MR-4, Dai Nippon Printing Co., Ltd) are disposed to face each other and lamination-joined to provide an optical film.

### Comparative Example 2

An optical film is prepared in accordance with the same procedure described in Example 5, except that the soft adhesive layer of Preparation Example 3 is applied to bind the polarizing film and the λ/2 phase delay layer instead of the UV-curable adhesive of Preparation Example 2, and the hard adhesive of Preparation Example 4 is applied to bind the λ/2 phase delay layer and the λ/4 phase delay layer instead of the UV-curable adhesive of Preparation Example 2.

### Comparative Example 3

An optical film is prepared in accordance with the same procedure described in Example 5, except that the hard adhesive layer according to Preparation Example 4 is applied instead of the UV-curable adhesive according to Preparation Example 2.

### Evaluation 2: Thickness of Optical Film

The optical films of Examples 5 and 6 and Comparative Examples 1 to 3 are evaluated for thickness.

The results are shown in Table 3.

TABLE 3

| | Total thickness of optical film (μm) |
|---|---|
| Example 5 | 28 |
| Example 6 | 28 |
| Comparative | 38 |
| Example 1 | |
| Comparative | 38 |
| Example 2 | |
| Comparative | 38 |
| Example 3 | |

Referring to Table 3, it is confirmed that the optical film of Examples 5 and 6 has a thickness which is reduced by about 10 μm when compared to the optical films of Comparative Examples 1 to 3.

### Evaluation 3: Appearance Evaluation of Folded Region

The optical films of Examples 5 and 6 and Comparative Examples 1 to 3 are evaluated for high temperature durability.

The high temperature durability is evaluated by performing a static bending test to measure whether the folded region is deformed and/or damaged or not. The static bending test is performed as follows: the optical films of Examples 5 and 6 and Comparative Examples 1 to 3 are folded between two stainless steel sheets with a curvature radius (r) of 3 mm, fixed and allowed to stand at 85° C. for 240 h, and then unfolded to evaluate whether the folded region is deformed or not.

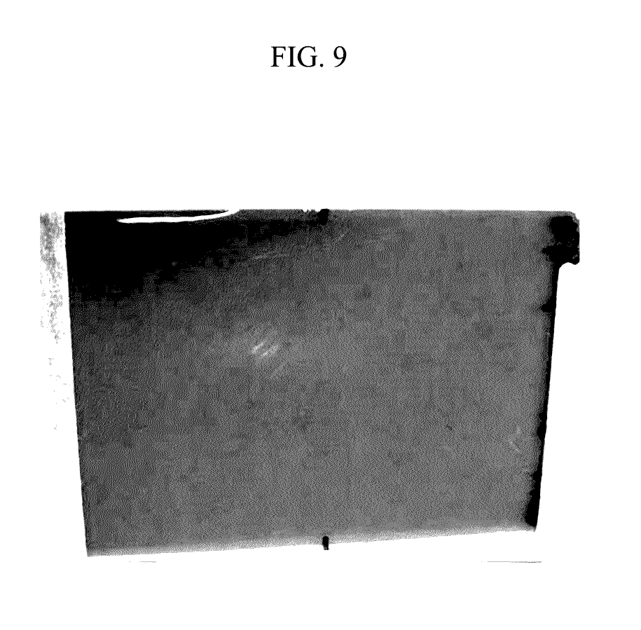

The results are shown in FIGS. 9 to 14.

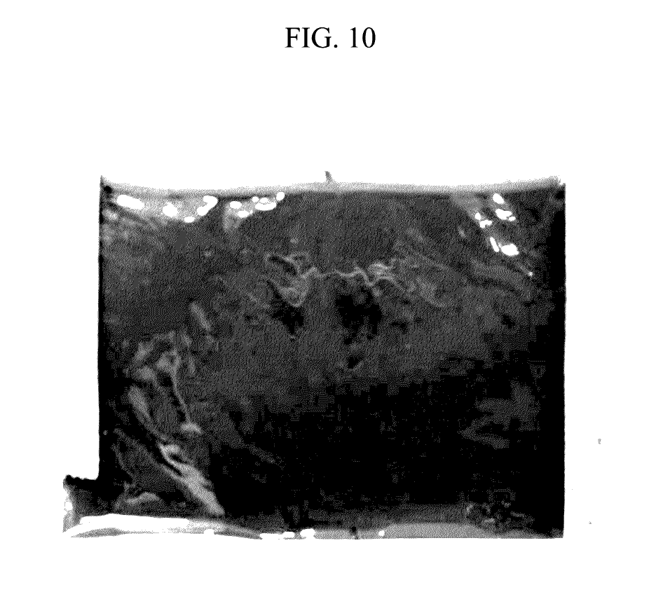

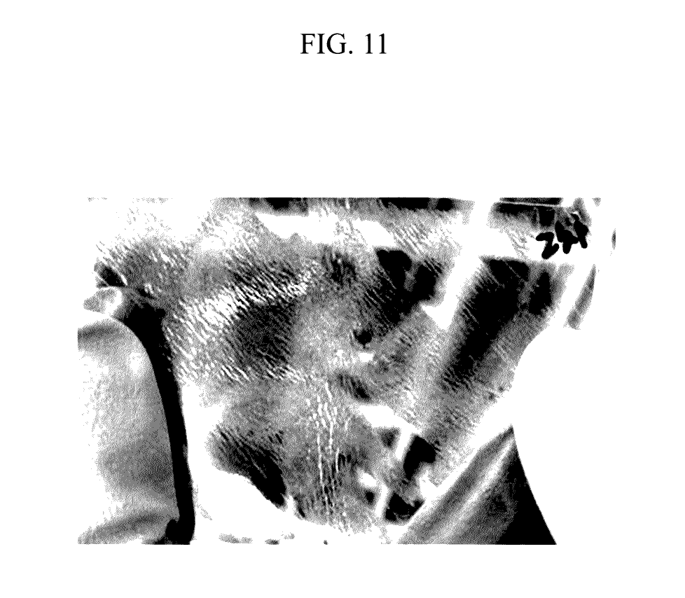

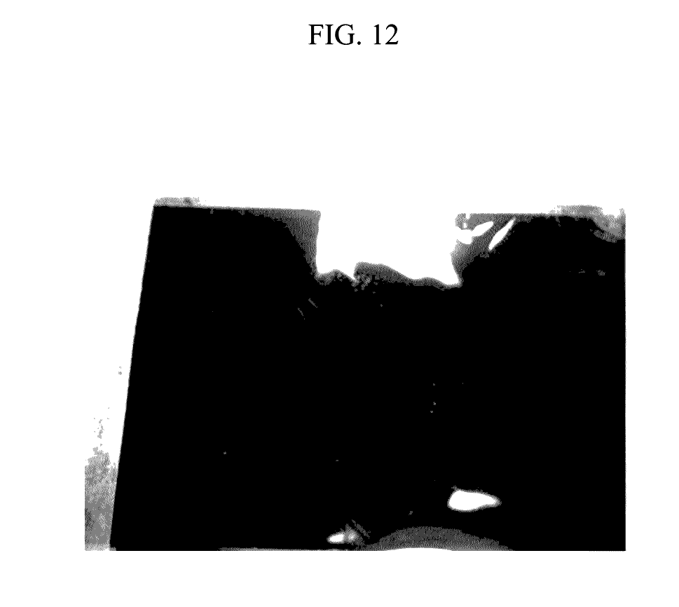

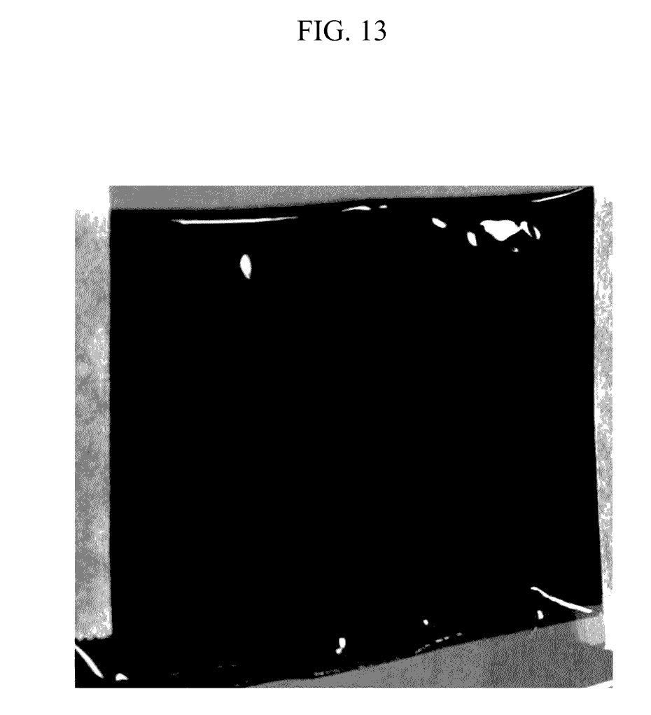

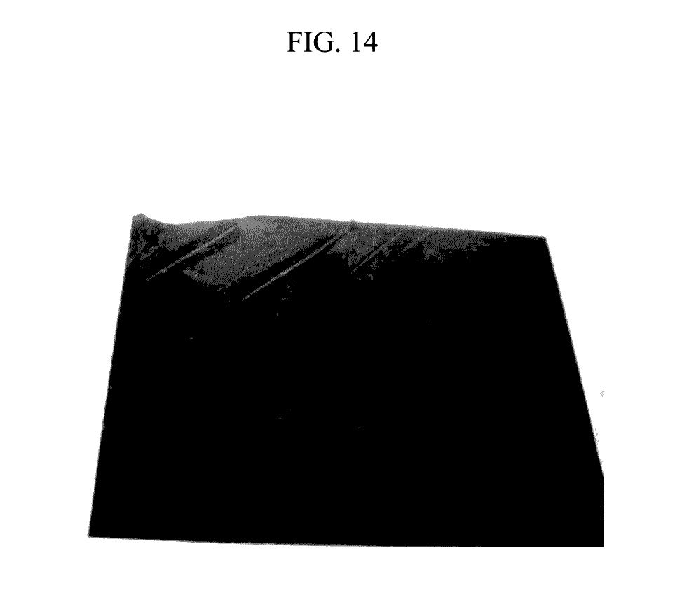

FIG. 9 is an appearance photograph of the optical film of Example 5 after performing a bending test; FIG. 10 is an appearance photograph of the optical film of Example 6 after performing a bending test; FIG. 11 is an appearance photograph of the optical film of Comparative Example 1 after performing a bending test; FIG. 12 is an appearance photograph of the optical film of Example 5 attached with a reflector after performing a bending test; FIG. 13 is an appearance photograph of the optical film of Example 6 attached with a reflector after performing a bending test; and FIG. 14 is an appearance photograph of the optical film of Comparative Example 1 attached with a reflector after performing a bending test.

Referring to FIG. 9 to FIG. 14, it is confirmed that the optical films of Examples 5 and 6 have no cracks or wrinkles on the folded region. On the other hand, it is confirmed that the optical film of Comparative Example 1 has many cracks and wrinkles along a diagonal line on the folded region.

Thereby, it is confirmed the optical films of Examples 5 and 6 have excellent high temperature durability.

### Evaluation 4: Evaluation of Surface Hardness

The optical films of Example 5 and Comparative Examples 1 to 3 are evaluated for surface hardness.

The surface hardness is evaluated by measuring hardness and tensile modulus of the λ/4 phase delay layer side and the polarizing film side of optical film of Example 5 and Comparative Examples 1 to 3 using a surface hardness tester (Fischerscope® HM2000).

Elastic Modulus (E_{IT}) and indentation Hardness (H_{IT}) can be calculated using a maximum loading force (Fₘₐₓ), an indentation depth from the surface, and time, on a simulation software program.

The hardness can be calculated by Equation 1:

$${H}_{IT} = \frac{{F}_{max}}{{A}_{p}} \qquad [ Equation 1 ]$$

In the Equation 1,

H_{IT} is an indentation Hardness,

Fₘₐₓ is a maximum loading force, and

Aₚ is a projected contact area.

The modulus can be calculated by Equation 2:

$$\frac{1}{{E}_{r}} = \frac{1 - {v}^{2}}{{E}_{IT}} + \frac{1 - {v}_{i}^{2}}{{E}_{i}} \qquad [ Equation 2 ]$$

In the Equation 2,

Eᵣ is a reduced Elastic Modulus,

Eⱼ is an Elastic Modulus of Indenter,

E_{IT} is an Elastic Modulus of the sample,

γ is a Poisson's ratio of the sample, and

γᵢ is a Poisson's ratio of the indenter.

For example, Elastic Modulus (Eᵢ) and Poisson's ratio (γᵢ) of a diamond penetrator are about 1141 GPa and 0.07, respectively.

The reduced Elastic Modulus can be calculated by Equation 3:

$${E}_{r} = \frac{\sqrt{π}}{2 β} \frac{S}{\sqrt{{A}_{p}}} \qquad [ Equation 3 ]$$

In the Equation 3,

S is a contact stiffness, and

β is a correct coefficient of the indenter's shape.

For example, the correct coefficients of an axis symmetry-shaped indentor, a quadrangular pyramid shaped-indentor and a triangular pyramid shaped-indentor are 1.000, 1.012, and 1.034, respectively.

The evaluations are performed 5 times, in condition of 1 mN of a maximum loading force and 20 seconds, and calculated the average

The results are shown in Table 4.

TABLE 4

| | Polarizing film side | | λ/4 phase delay layer side | |
|---|---|---|---|---|
| | Surface | | Surface | |
| | hardness | Modulus | hardness | Modulus |
| | (N/mm²) | (MPa) | (N/mm²) | (MPa) |
| Example 5 | 96.6 | 2218 | 94.3 | 2157 |
| Comparative | 68.3 | 1173 | 1.9 | 62 |
| Example 1 | | | | |
| Comparative | 85.1 | 1475 | 2.5 | 86 |
| Example 2 | | | | |
| Comparative | 95.6 | 1733 | 4.3 | 178 |
| Example 3 | | | | |

Referring to Table 4, it is confirmed that the optical film of Example 5 has excellent hardness and tensile modulus on both the polarizing film side and the λ/4 phase delay layer side as compared to the optical films of Comparative Examples 1 to 3. It is also confirmed that, for example, the optical film of Example 5 has a surface hardness of greater than or equal to about 90 N/mm² and a tensile modulus (MPa) of greater than or equal to about 1800 MPa on both the polarizing film side and the λ/4 phase delay layer side.

While this disclosure has been described in connection with what are presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An optical film comprising:
a polarizing film comprising a polyolefin and a dichroic dye;
a phase delay layer positioned on the polarizing film; and
a curable adhesive positioned between the polarizing film and the phase delay layer.

2. The optical film of claim 1, wherein the curable adhesive is a photo-curable adhesive or a thermosetting adhesive.

3. The optical film of claim 1, wherein the curable adhesive has a thickness of less than or equal to about 5 μm and a peeling force from the polarizing film of greater than or equal to about 20 gf/25 mm.

4. The optical film of claim 1, wherein the polarizing film is treated with one or more of a corona treatment, a plasma treatment, and a halogenation treatment.

5. The optical film of claim 1, further comprising an auxiliary layer positioned between the polarizing film and the curable adhesive.

6. The optical film of claim 5, wherein the auxiliary layer comprises a halogenated polyolefin.

7. The optical film of claim 1, wherein the phase delay layer comprises a first phase delay layer and a second phase delay layer having different in-plane retardation from each other, and
further comprises a curable adhesive positioned between the first phase delay layer and the second phase delay layer.

8. The optical film of claim 7, wherein the in-plane retardation of the first phase delay layer ranges from about 230 nm to about 300 nm for a wavelength of 550 nm; and
the in-plane retardation of the second phase delay layer ranges from about 110 nm to about 160 nm for a wavelength of 550 nm.

9. The optical film of claim 1, wherein the phase delay layer comprises liquid crystal molecules.

10. The optical film of claim 9, wherein the phase delay layer comprises a first phase delay layer and a second phase delay layer having different in-plane retardation from each other and each comprising the liquid crystal molecules, and
further comprises a curable adhesive positioned between the first phase delay layer and the second phase delay layer.

11. The optical film of claim 1, wherein the phase delay layer has a thickness of less than or equal to about 10 μm.

12. The optical film of claim 1, wherein the polarizing film has a thickness of less than or equal to about 100 μm.

13. The optical film of claim 1, wherein the optical film has a tensile modulus of greater than or equal to about 1800 MPa and surface hardness of greater than or equal to about 90 N/mm² as measured for each of the polarizing film and the phase delay layer.

14. A display device comprising the optical film of claim 1.

15. A method of manufacturing an optical film, comprising:
melt-blending a polyolefin and at least one dichroic dye to prepare a polarizing film;
providing a phase delay layer; and
binding the polarizing film and the phase delay layer using a curable adhesive.

16. The method of claim 15, wherein providing the phase delay layer comprises providing a liquid crystal layer.

17. The method of claim 16, further comprising:
applying the curable adhesive on the polarizing film after preparing the polarizing film,
wherein binding of the polarizing film and the phase delay layer comprises disposing the curable adhesive to face the liquid crystal layer, and transferring the phase delay layer onto the curable adhesive.

18. The method of claim 15, wherein providing the phase delay layer comprises providing each of a first phase delay layer and a second phase delay layer, and binding the first phase delay layer and the second phase delay layer using a curable adhesive, wherein the first phase delay layer and second phase delay layer have different in-plane retardation from each other.

19. The method of claim 15, further comprising treating the polarizing film with one or more of a corona treatment, a plasma treatment, and a halogenation treatment after preparing the polarizing film.

20. The method of claim 15, further comprising disposing an auxiliary layer comprising a halogenated polyolefin on one side of the polarizing film after preparing the polarizing film.
